(19) United States
(12) Patent Application Publication
(10) Pub. No.: US 2004/0126462 A1
(43) Pub. Date: Jul. 1, 2004

(54) Pet chews with filled receptacles and method of making same

(75) Inventors: Jacob Tepper, Boca Raton, FL (US); Steven Mendal, New York, NY (US); Dean Triandafellos, Freehold, NJ (US)

Correspondence Address: WEINGRAM & ASSOCIATES P.C., P.O. BOX 927, MAYWOOD, NJ, 07607, US

(73) Assignee: PETRA PET, INC. d/b/a PETRAPPORT

(21) Appl. No.: 10/687,560

(22) Filed: Oct. 16, 2003

Related U.S. Application Data
(60) Provisional application No. 60/419,744, filed on Oct. 18, 2002.

(51) Int. Cl. A23L 1/00

(52) U.S. Cl. 426/89

(57) ABSTRACT

A consumable pet chew comprising a formed, three-dimensional body of chewable material, and a method of making same, are disclosed. The body has an outer surface and at least one recess extending generally perpendicularly from the outer surface. The recess has walls and a machined edge at said outer surface, and defines a receptacle within the body of the pet chew. A filling comprising an edible substance is fixedly positioned in the receptacle. The machined edge at the outer surface of the body is formed by machining operations selected from the group consisting of drilling, punching, cutting and stamping. The walls of the recess are scored during machining operations to enhance retention of the filling in the receptacle. The chew is attractive to dogs as it combines the flavor of the chewable material forming the body of the chew with one or more differently flavored fillings.

### BACKGROUND OF THE INVENTION

1. Field of the Invention

The present invention relates to pet chews for dogs, and a method of making same. More particularly, this invention relates to multi-flavored dog chews, and specifically, filled chews which appeal to dogs and are long lasting.

2. Description of the Related Art

Teething toys and dog chews of rawhide, jerky, nylon, polyurethane, plastic and other synthetic materials are known to satisfy a dog's instinctive urge to chew, reduce plaque build-up and massage gums. Prior dog chews made of rawhide, rolled and knotted in the shape of a bone or other shapes, satisfy a dog's need to chew and are easier to digest than chews made of synthetic materials. Basting or coating chews in flavoring marinades enhances the taste and aroma of the rawhide chews and stimulate and maintain a dog's interest in the chew. However, flavored dog chews may stain carpets and some people find their aroma unpleasant. Studies have shown that dogs prefer multi-flavored chews. Accordingly, there is a need for a multi-flavored chew which appeals to dogs, is long-lasting, satisfies a dog's need to chew and cleans the dog's teeth, yet which does not stain carpets or smell unpleasant.

Numerous references describe the production of dog chews. However, none of these references teach or suggest the novel dog chew of the invention.

U.S. Pat. No. 5,673,653 to Sherrill discloses a dog chew made by wrapping or folding a sheet of rawhide with a sheet of jerky superimposed on it.

U.S. Pat. No. 6,223,693 to Perlberg et al. discloses a hard or soft rawhide sheet wrapped around a soft, chopped rawhide center.

U.S. Pat. No. 6,238,715 to Baikie discloses a method of making a filled chew toy comprising pouring a liquid meat mixture including a gelling agent into a natural bone. The aqueous meat mixture and gelling agent are heated outside the bone, and then poured into a cavity in the bone. The filled bone is then cooled, causing the filling to solidify.

U.S. Pat. No. 6,277,420 to Andersen discloses a dog chew comprising a rawhide outer fraction or shell filled with a material that has an emulsified meaty filling that has gelled. The meaty filling has a water activity level such that it will not bleed or migrate into the rawhide outer shell, which is dehydrated to less than 8% moisture.

However, among the foregoing patents, none disclose or suggest the multi-flavored dog chews of the invention which are devised to appeal to a dog's chewing instincts, and a method of making same. The present invention comprises an improved pet chew which has an attractive and pleasing taste, color, and appearance, and is suitable as a plaything or dog food.

### OBJECTS AND SUMMARY OF THE INVENTION

It is an object of the invention to produce an improved pet chew which satisfies a dog's chewing instincts and which appeals to the dog so the dog is initially attracted to and sustains interest in chewing the pet chew for extended periods of time.

It is an object of the invention to provide a novel, consumable pet chew which has at least one receptacle having a machined edge and filled with one or more differently flavored edible fillings which are attractive to dogs.

It is a further object of the invention to provide pet chews having receptacles filled with an edible filling selected from the group consisting of rawhide, poultry, meat, pork, jerky, a meat by-product mixture, cereal, rice, vegetable, fruit, cheese, pet food, peanut butter, and mixtures thereof and binders therefor.

A further object of the invention is to provide a dog chew which does not stain carpets or objects and does not have an offensive odor.

Yet another object of the invention is to provide a long-lasting dog chew that piques a dog's interest and maintains its integrity so that it is suitable for repeated use.

Yet another object of the invention is to provide a dog chew which is multi-flavored and attractive to dogs.

Another object of the invention is to provide a dog chew toy that help keeps a dog's teeth plaque and tarter-free and that massages the dog's gums when the dog chews on the chew.

A final object of the invention is a method of making a dog chew that is easy and economical.

These and other objects are accomplished by providing dog chews which are improved as compared to commercially available dog chews, as they are made from a chewable material, preferably rawhide, configured in various shapes and sizes, and having receptacles which are filled with filling sized and configured to fit in the receptacles and be retained in position therein by friction fit or by other means such as an edible adhesive or heat seal. The filling may be selected from a variety of edible fillings including raw or cooked chicken, meat, pork, a contrasting colored or flavored rawhide, jerky, a meat by-product mixture, or other filling such as cereals, rice, vegetables, fruits, cheese, pet food, peanut butter, mixtures thereof and binders therefor. The chew is attractive to dogs as it combines the rawhide flavor of the body of the chew with one or more differently flavored fillings. The attractant is held in the cavity and is not easily or quickly broken or dislodged until the filling is consumed, degraded, or dissolved by the pet's chewing. Thus, the multi-flavored chew holds the dog's interest for a substantial period of time.

In another aspect of the invention, there is disclosed a method of making a consumable pet chew comprising the steps of forming an edible, chewable material into a three dimensional body; removing a portion of the body to form at least one recess having walls and defining a receptacle in the body; forming an edible filling; and fixedly positioning the filling in the receptacle. The walls of the recess are preferably scored during machining operations to enhance retention of the filling in the receptacle. The chew may include multiple receptacles which may be filled with the same or a variety of different fillings. Various colorants, flavorants, scents, nutrients, dental additives, and pharmaceutical compounds may be added to the chewable material or to the filling or both.

These, and various other and further features and advantages of the invention will become apparent from the following detailed description, taken in conjunction with the accompanying drawings, which illustrate by way of example the principles of the invention.

### BRIEF DESCRIPTION OF THE FIGURES

FIG. 1 is a perspective view of the pet chew of the invention having two filled receptacles.

FIG. 2 is a top plan view of the pet chew of FIG. 1.

FIG. 3 is a bottom plan view of the pet chew of FIG. 1.

FIG. 4 is a perspective view of a second pet chew of the invention having four filled receptacles.

FIG. 5 is a top plan view of the pet chew of FIG. 4.

FIG. 6 is a bottom plan view of the pet chew of FIG. 4.

FIG. 7 is a perspective view of a third pet chew of the invention having six filled receptacles.

FIG. 8 is a top plan view of the pet chew of FIG. 7.

FIG. 9 is a perspective view of a fourth pet chew of the invention having three filled receptacles.

FIG. 10 is a top plan view of the pet chew of FIG. 9.

FIG. 11 is a bottom plan view of the pet chew of FIG. 9.

FIG. 12 is a perspective view of a fifth pet chew of the invention having eight filled receptacles.

FIG. 13 is a top plan view of the pet chew of FIG. 12.

FIG. 14 is a partial side view of a pet chew of the invention made of compressed rawhide showing a partial cross-section of the filling in a receptacle.

### DETAILED DESCRIPTION OF THE INVENTION

The present invention provides a nutritious, long-lasting, and completely digestible chew for dogs comprising a formed, three-dimensional body of chewable material. The body has an outer surface and at least one recess extending generally perpendicularly from the outer surface. The recess has walls and a machined edge at the outer surface. The recess defines a receptacle within the body. A filling comprising an edible substance is fixedly positioned in the receptacle. The walls of the recess are preferably scored, i.e., notched or scratched, during machining operations to enhance retention of the filling in the receptacle.

The chewable material forming the body of the chew is selected from the group consisting of natural rawhide, ground and recombined rawhide, starch, casein, denatured and partially hydrolyzed collagen, thermoplastic material, non-toxic plastic, and mixtures thereof.

The preferred chewable material is rawhide. Rawhide is the inner layer of the hide of any cleft-hoofed livestock, which has been dehaired and then dried, but not tanned. It is contemplated that the rawhide may be derived from cow hide or pig hide or the hide of other animals. It is understood that the rawhide may be compressed, extruded, ground and recombined rawhide, or in other known forms. Various appeal-enhancing agents may be added to the chewable material, such as seasonings, colorants, or meat-flavored attractants.

The filling is selected from the group consisting of rawhide, poultry, meat, pork, jerky, a meat by-product mixture, cereal, rice, vegetable, fruit, cheese, pet food, peanut butter, and mixtures thereof and binders therefor. Jerky is a nutrient-dense meat which has been dried to remove the moisture and to make it lightweight and shelf-stable, so that it may be stored without refrigeration. Other constituents suitable for animal consumption may be added to the filling, such as food-grade coloring which may be used to give a desirable tint to the filling. The filling may be flavored, or scented to enhance its appeal to the pet.

The invention also contemplates a method of making a consumable pet chew comprising the steps of forming an edible, chewable material into a three dimensional body, removing a portion of the body to form at least one recess having walls and defining a receptacle in the body, forming an edible filling, and fixedly positioning the filling in the receptacle. The walls of the recess are preferably scored during machining operations.

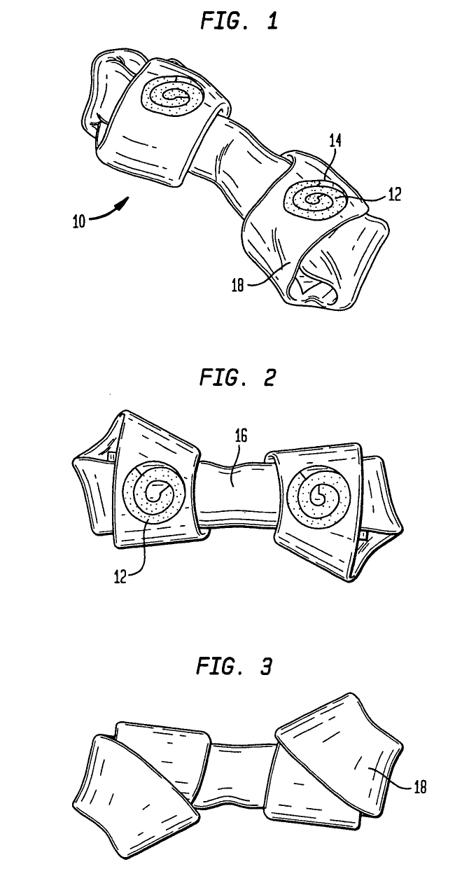

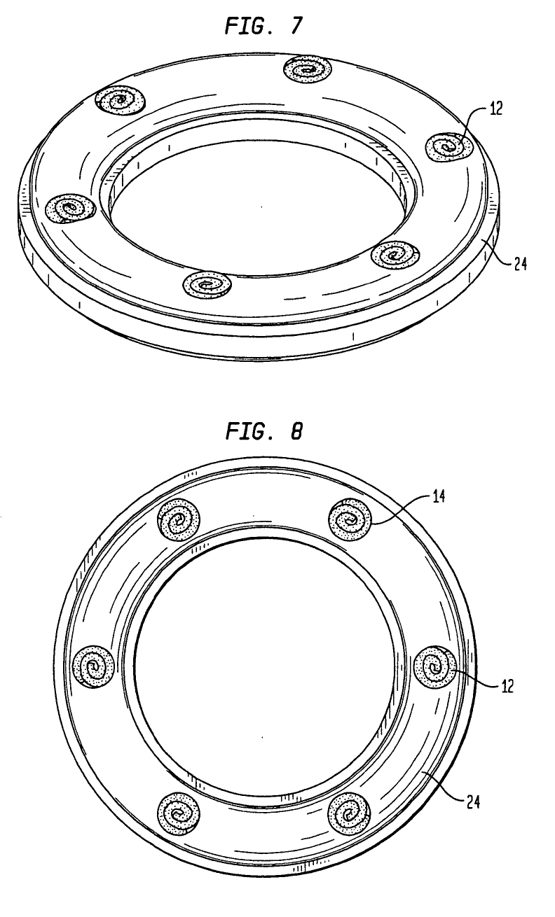

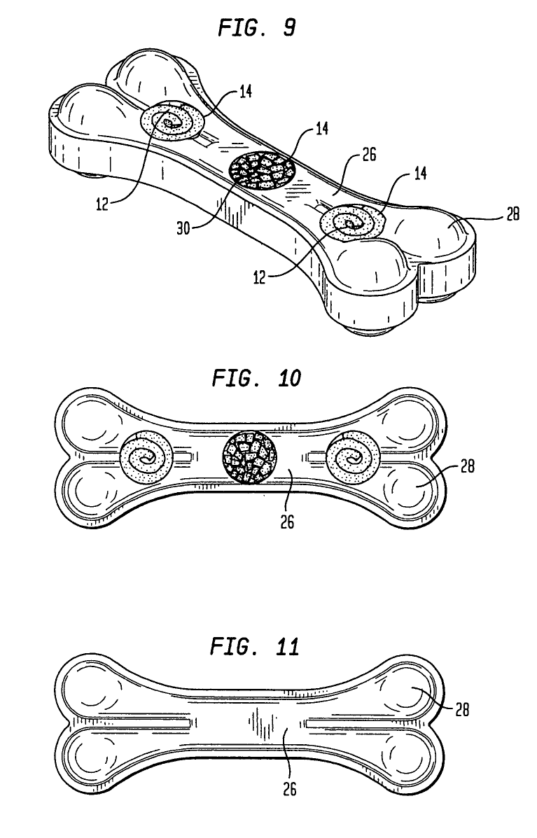

As shown in FIGS. 1 through 14, a pet chew, indicated generally by reference number 10, is made of a chewable material, preferably rawhide. The pet chew typically has the flavor of the rawhide, but the flavor may be enhanced or changed by soaking, flavoring, or smoking the rawhide dog chew, as is known in the art.

While not critical to the invention, it is clear that the rawhide may be cut and shaped to any desired appearance and configuration to appeal to dogs. For example, the chew may be in the configuration of bones, sticks, pretzels, balls, rings, rolls, donuts, pancakes, retrieving objects, twists, or any other actual, novelty, or abstract shape. Chews of different sizes and configurations may be formed by varying the length, width, and thickness of the rawhide, suitable for dogs of different breeds and sizes. The pet chew is designed to be so that a dog can easily hold it in its mouth, but cannot easily swallow it whole. The pet chew is preferably in the shape of a knotted or compressed bone.

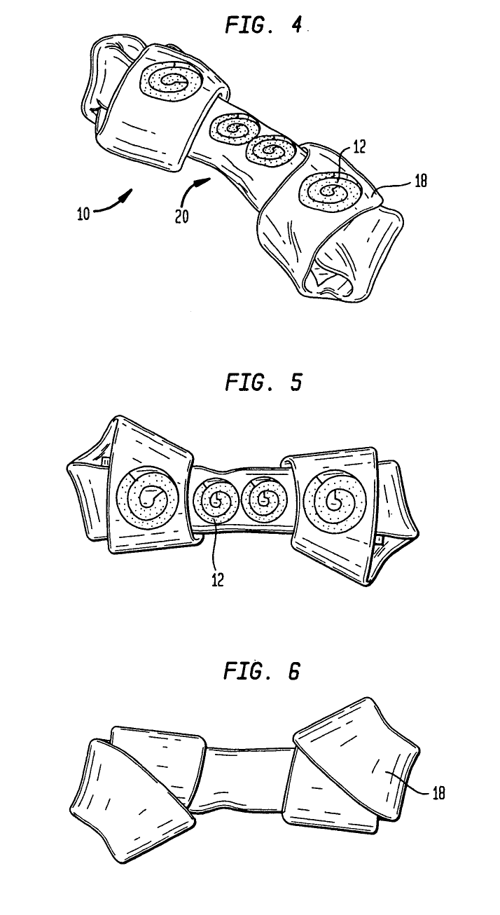

Turning to the figures, it is pointed out that similar numerals refer to similar parts throughout the drawings. FIGS. 1 through 6 show knotted rawhide bones and FIGS. 7 through 14 show compressed rawhide having a body in a ring configuration (FIGS. 7 and 8) or a bone configuration (FIGS. 9 through 14). FIGS. 1 through 3 show a knotted rawhide bone 16 having two fillings 12 of twisted meat fixedly retained in the receptacles 14 which are regularly spaced in the knotted ends 18 of the bone 16. The receptacle 14 extends only partially through the body of the chew 10 and does not extend to the opposite end of the bone 16, as can be seen in FIG. 3. FIGS. 4-6 show a knotted bone 20 similar to that shown in FIGS. 1-3, except that the bone is larger and accommodates four fillings 12 in receptacles 14. Two of the fillings 12 are in the shank 20 of the bone, and a third and fourth are positioned at opposite ends, in the knotted portions 18 of the bone.

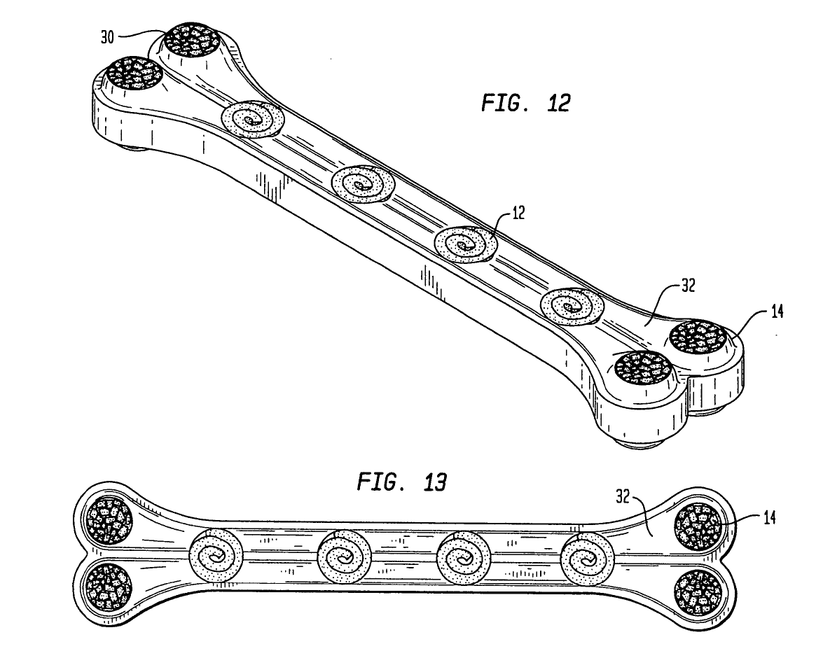

FIGS. 7 and 8 show a compressed rawhide ring 24 having six receptacles 14 filled with filling 12 comprising twisted meat slices. FIGS. 9-11 show a compressed bone 26 with bulbous ends 28. The shank of the bone 26 has three receptacles 14 filled with various fillings. The outer fillings 12 are formed of whole pieces of an edible substance, and the center filling 30 is formed of discrete particles of an edible substance. FIGS. 12 and 13 show a compressed bone 32 having filled receptacles 14 positioned both in the bulbous ends 28 of the bone 32 and along the shank. The fillings 12 along the shank are formed of whole pieces of an edible substance, while those at the ends are formed of discrete particles.

When consuming the pet chew, the dog sinks its teeth into the chew and rubs the chew against its gums while savoring the latent flavor. These efforts not only exercise the dog's teeth, jaws and gums, but also clean the dog's teeth by the abrasive wiping, chewing, and gnawing action of the chew against the surface of the teeth and gums. Tarter or plaque on the pet's teeth is reduced by the action of chewing and rubbing of the chew against the teeth. As the dog has a sustained interest in the chew, the prolonged chewing time results in an increase in the abrasive effect on the dog's teeth surfaces. This helps control plaque and tartar build-up which can lead to gum disease and bad breath.

The pet chew of the invention comprises a combination of a body formed of a chewable material having one or more of the same or differently flavored fillings 12, 30 positioned in receptacles 14 formed in the body by a machining operation such as drilling, punching, cutting and stamping. The filling is preferably a meat filling, as dogs find the smell and taste of meat appetizing and attracting. As the chew toy is so palatable to the dog, the dog will enjoy chewing on it, attempting to consume the meat filling. The rawhide, being heavy, dense, and rigid, provides a long-lasting release for the dog's natural chewing instincts. At the same time, the meat's odor, flavor, and color initially attract the dog's attention and sustain the dog's interest to continue chewing on the chew toy. The chew is thus of long-lasting interest to the dog. The palatability of rawhide and meat ensures hours of chewing enjoyment for the dog, while at the same time having a beneficial tartar-removing, gum-massaging effect on the dog's teeth.

At least one recess having walls and a machined edge at the outer surface of the body extends generally perpendicular from the outer surface of the body of the pet chew. The recess defines a receptacle. One or more receptacles are machined in the pet chew at regular or irregular intervals, as desired, and filled with one or more of the same or differently flavored, colored, or scented fillings. The walls of the recess are scored during machining operations to aid in retaining the filling in the receptacle. The receptacles may be formed by means of machining operations selected from the group consisting of drilling, punching, cutting and stamping. The receptacles may extend fully through the body of the pet chew, or only partially through the body. The receptacle may have the configuration of a cylindrical bore, or of a three dimensional cavity of any known or desired shape, including geometrical configurations.

The filling is lodged in the receptacle and is not easily displaced or removed. The filling, which may be referred to herein as a “meat plug”, is exposed to view on the surface of the pet chew and tempts the dog to continue chewing, to obtain the filling. Optionally, the filling may extend or project up above the surface of the body of the chew, to provide a raised portion of the chew on which the dog can begin to chew, and to initially serve to attract the dog to begin chewing. Thus, the filling serves as an attractant and incentive to the dog and as a starting point for the dog to begin chewing.

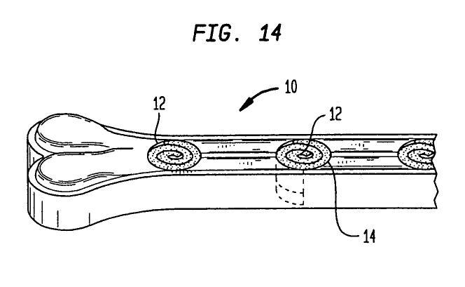

Multiple receptacles filled with meat plugs may be provided on one surface of the chew, each receptacle extending a substantial distance through the chew as can be seen in the cross-sectional view of FIG. 14. As shown in FIGS. 9 and 10, the pet chews may include varying fillings, i.e., a meat plug of twisted chicken or meat alternating with a meat plug of ground or granulated chicken or meat. Thus, the chew toy has a tempting flavor and odor substantially throughout the chew. Advantageously, the filling is at or near the surface of the chew, and continues a distance substantially through the depth of the chew, to initially entice the dog with its taste and aroma, and to maintain the dog's interest as the chew is consumed. As the ratio of rawhide to filling is substantially greater, the dog must consume the rawhide to get to the entire filling. This will satisfy the dog's chewing urges, keep its teeth clean, and help prevent tarter and plaque build-up, while the flavor and aroma of the filling encourage the dog to continue chewing for long periods of time.

The rawhide chew toy is preferably in the shape of a bone which is a thick, solid, chew-resistant product which can exercise a dog's teeth and jaws. Rawhide bones are known in the art and are typically made by known processes. Rawhide is obtained from the natural skins of animals, most commonly cows, but rawhide may also be obtained from the skins of pigs, goats and water buffalos. The animal's skin is split into inner and outer layers. The top or outer layer or grain is usually tanned and used to make leather products. The inner layer of the hide, in its natural, untanned state, is rawhide which is used to make edible chew toys for dogs.

The rawhide is treated, washed and cleaned by putting the rawhide split in a wooden drum, revolving with flowing clean water for about one hour. To neutralize the alkalinity of the rawhide split, ammonium sulphate solution of 5% density is added to the wooden drum, and the drum is revolved for two hours. This is followed by washing with flowing clean water for an additional hour, until the pH reaches 7. The rawhide is then subjected to a disinfection and bleaching treatment in hydrogen peroxide solution of about 27.5% density for 12 hours. Excess water is then removed, such as by squeezing water out of the skin by pressing the hides between two pinch rollers. The rawhide is then cut into proper size for the products that are to be made. The cut skins are then formed by hand into the desired shapes or configurations of the products, i.e., bones or other shapes. For the sake of convenience, the shaped rawhide products will be referred to herein as rawhide bones, although other rawhide shapes and configurations are envisaged, so long as these rawhide products are capable of having receptacles machined in them and which are capable of retaining a filling in position. As the rawhide bones still contain absorbed water, the rawhide bones are then dehydrated and dried by subjecting them to temperatures in the range of 40° C.-65° C. for at least 36 hours, to produce the finished rawhide products.

Alternative methods of forming rawhide chews are known in the art and may be followed, so long as a hard, chew-resistant product is made which is capable of having cavities or bores drilled or machined therein, which receptacles may be filled with a filling.

The rawhide chew toy of the invention is preferably made of strips of rawhide cut, shaped and knotted in bone shape, or alternatively of pressed rawhide. However, it is contemplated that the chew toy may be formed from rawhide by any convenient technique known in the art, such as by extrusion, grinding, press molding or injection molding into preselected shapes, so long as the chew may be machined to form receptacles.

Attractants, such as beef, chicken, or ham flavoring, or mixtures thereof, as well as other flavorings and colorings, may be added in minute quantities to the rawhide or to the filling to enhance the chew's appeal to dogs as well as to purchasers. Preferably, at least one of the chewable material and the filling is impregnated with an effective amount of a fluorine compound to protect against tooth decay, by means known in the art. This may be accomplished by immersing the rawhide into an aqueous solution comprising the fluorine compound, at sufficient pressure and temperature as is known in the art, for a sufficient time so that the aqueous fluorine solution penetrates into the surface of the rawhide.

The shaped, dried rawhide bones are then further treated by drilling cavities or bores in the rawhide bones using a standard drill. The bores are preferably circular in cross-section, but may assume any desired size or shape. Different drills may be used to form various sized receptacles. The bores preferably vary in size depending on the size and length of the shaped rawhide product. The bit size of the drill is varied to obtain bores of different diameters. The following bore diameters are preferred, but it is understood that the bore diameters may be varied without detracting from the scope of the invention: It is preferred to drill 16 mm bores in 4 inch compressed bones; 18 mm bores in 6 inch long compressed bones; 20 mm bores in 8 inch long compressed bones; 22 mm bores in 10 inch long compressed rawhide bones; 26 mm bores in 12 inch long compressed rawhide bones. For knotted bones, it is preferred to drill 16 mm bores in 3 inch knotted bones; 18 mm bores in 3.5 and 5 inch knotted bones; and 22 mm in 7 inch knotted bones.

The depth of the bores or cavities that are drilled may also vary, but it is preferred that the bores have the following depths: In compressed rawhide bones, it is preferred that the bores be 10 mm deep for 4 inch compressed rawhide bones; 12 mm deep for 6 inch compressed rawhide bones; 14 mm deep for 8 inch compressed rawhide bones; 16 mm deep for 10 inch compressed rawhide bones; and 17 mm deep for 12 inch compressed rawhide bones. For knotted bones, the preferred depth of the cavity is 10 mm for a 3 inch knotted bone; 10 mm for a 3.5 inch knotted bone; 10 mm for a 5 inch knotted bone; and 12 mm for a 7 inch knotted bone.

The filling is retained in position in the receptacle. The filling is shown in the figures as preferably having a circular cross section, but may have a more irregular shape to conform to the shape of the receptacle.

The preferred number of bores per rawhide bone is at least two. For compressed rawhide bones which are under 8 inches long, the preferred number of bores is three. For 6 inch long or longer compressed rawhide bones, the preferred number of bores is four to eight. For knotted bones, the preferred number of bores is 2 bores for 3 and 3.5 inch knotted bones; 3 bores for 5 inch knotted bones; and 4 bores for 7 inch knotted bones. It is understood that the number of bores may vary.

When drilling the bores, care is exercised to prevent the drill from either burning or distorting the rawhide material around the bore. By drilling slowly, it is possible to insure that the drill does not overheat and burn the surrounding rawhide. If it appears that the drill is excessively hot and may result in burning of the rawhide, the drill is withdrawn and allowed to cool down before proceeding.

The filling may comprise chicken, meat, pork, slices or sections of animal bowel which are twisted. The twists may be combined with cooked rice, which functions as a filler or binder. A preferred method of preparing the filling is by obtaining meat, such as chicken breast, and cutting it into slices, preferably about 10 mm thick. The chicken slices are placed in a bowl and a sufficient amount of edible food coloring is added to tint the chicken meat a desirable shade resembling red meat. The food coloring is preferably a red pigment, to resemble the coloring of meat, so as to enhance its appeal to a dog. The tinted, sliced chicken meat is then hand-twisted into a long roll. The roll is then cut by hand to the depth of the cavities, to form plugs which conform to and approximate the shape and size of the cavities. The pre-formed plugs of color-enhanced chicken meat are then forced by hand into the cavities drilled in the rawhide chews, so that a tight friction-fit of the plug in the cavity is achieved. The plug is retained in the cavity by means of said tight-friction fit.

As the bore is drilled into the rawhide shaped product, the walls of the bore are not even, smooth and level, but rather are rough, uneven, slightly irregular, or possibly indented due to the frequent insertion and removal of the drill into the rawhide body as the cavity is drilled, to prevent overheating and burning of the rawhide chew. Due to the irregularity and roughness of the walls of the receptacle, when the plug is forced into the receptacle, the irregular edges of the plug engage with the irregular edges of the receptacle, and are lodged into position by this engagement. Thus, in addition to the friction fit of the plug in the receptacle, the plug is maintained in position by the engagement of the walls of the plug with the slightly-irregular walls of the receptacle. This prevents the plug from falling out in transit and prevents the dog from easily popping the plug out and consuming it immediately.

An advantage of the pet chew of the invention is that the filling is substantially retained in the receptacle and away from household surfaces so as to reduce staining of carpeting or flooring, as the flavored filling is rarely in contact with such surfaces. A further advantage is that dogs tend to spend considerable time and effort gnawing on the chew, either due to the texture, odor, and taste of the chew or the dog's inability to reach the meat filling. In addition, the outer surface of the chew preferably includes ridges, bumps or other protrusions which help clean a pet's teeth as it chews.

The filling is fixedly positioned in the receptacle by any suitable means, such as by friction fit. If desired, the meat plug may be secured in the receptacle by various fixing means, such as by means of a non-toxic food grade quality hot melt adhesive, such as rawhide glue, or by means of heat sealing. Optionally, a suitable adherent material, such as gum arabic or other suitable vegetable gum, may be coated or brushed in the cavity, or may be present in a mixture with the meat. When applied as a separate coating, the gum arabic is applied to the chew by brushing, spraying, dipping or by other means known in the art onto the surfaces of the cavity and is allowed to dry as necessary for adhering purposes. This increases the adherence of the plug to the surfaces of the cavity. Multiple coatings of the gum arabic may be applied. Alternatively, the gum arabic may be mixed with the meat and when inserted into the cavity, the gum arabic aids the plug to adhere to the cavity.

Alternatively, the filling is fixedly positioned in the bore or cavities by means of a thermosetting edible compound, i.e., liquid egg or dried egg solids which set when heated. When the pet chew is dried, heated and sterilized, the egg wash hardens and seals the filling in position. The filling may also be retained in position by means of a tight-fitting, removable wrapper or covering which is placed around the pet chew. Wrapping the pet chew after the drying and sterilizing step also prevents oxidation of the contents.

The plug may be forced by hand into the receptacle. The top surface of the filling may be shaped to the desired configuration. Excess plug material which extends up out of the receptacle may be trimmed by hand using a small knife, razor blade or other suitable instrument to smooth the top surface of the filled receptacle to make it substantially level with the surrounding rawhide. A wet cloth may be used to wipe around the surface of the filled chew to remove any loose particles of filling and to clean the surface. Optionally, a portion of the plug may be shaped to extend outwardly of the receptacle to provide a starting point for the dog to chew and as an attractant to the dog.

The filling may be formed from whole pieces of an edible substance, as described above, and as shown in FIG. 1. The filling may optionally be formed from discrete particles of an edible substance, as shown in the center filling of the pet chew of FIG. 9. This filling is prepared by grinding chicken or meat. Optionally, a paste of the granulated or ground chicken or meat may be prepared by adding a binder such as rice. The discrete particles of ground chicken or meat or the meat paste is then spooned or filled into the receptacle and fixed in position by means of a food-grade adhesive or by other known means. Alternatively, the filling may comprise a processed mass, such as cheese or other spread.

The filled rawhide chews are then subjected to drying and sterilizing by exposing said filled pet chew to a suitable temperature for a sufficient time to effect drying and sterilizing, as is known in the art. A preferred process is to heat the filled chews to a temperature of 60° C. for about 48 hours, so as to dry the filled pet chews. The dried, filled rawhide chews are then sterilized by subjecting them to temperatures of about 80° C. for about 24 hours and then subjecting them to ultraviolet light for about a half-hour to destroy all microorganisms. It is preferred to use an ultraviolet light having six ultraviolet lamps of at least 40 watts each, but any suitable method may be used. After drying and sterilizing, the chew may be wrapping to prevent oxidation.

The hardness of the filling may be controlled by a variety of methods, for example, by varying the pressure used to compact the filling, or the relative amount of meat filling used, or the amount of liquid in the filling. The filling may be made of any animal food component which has a satisfactory shelf-life, including air dried, freeze-dried, irradiated, etc., foods, such as meat, fish, poultry, or poultry meal, rawhide, jerky, cereals, vegetables, fruits, wheat germ, peanut butter, etc. which are commonly available commercially.

Optionally, food additives or supplements may be added to the filling, such as spices, extenders, vitamins, minerals, food additives, medicines or other supplements, such as chemicals or enzymes capable of plaque and/or tartar removal from the animal's teeth. Attractants, such as various meat flavorings, as well as colorings, can be added in very small quantities to enhance the appeal of the dog chew to both the pet and the pet owner. Preferably, the dog chew should be non-staining so as not to discolor or damage clothing, carpets, or furniture.

At least one of the chewable material and the filling of the pet toy may incorporate at least one nutrient selected from the group consisting of vitamins, minerals, herbs, and nutritional supplements. The vitamins may be selected from the group consisting of vitamins A, C, D, E, B₁, B₂, B₁₂, K, biotin (vitamin H), thiamine, niacin, folic acid, riboflavin, and mixtures thereof. The nutritional supplements may include glucosamine and chondroiton. The mineral may be selected from the group consisting of calcium, potassium, sodium, chloride, magnesium, phosphorus, iron, copper, manganese, zinc, iodine, selenium, cobalt, and mixtures thereof. The herbs may be selected from the group consisting of echinacea, St. Johns Wort, Ginkgo biloba, ginseng, goldenseal, camomile and mixtures thereof. These nutrients are added, in proper amounts and ratios as is known in the art, for optimum pet nutrition and health.

At least one of the chewable material and the filling of the pet toy may incorporate a dental additive, which may include anti-plaque and anti-tartar agents, breath fresheners, and cleaning abrasives. The dental additive may be selected from the group consisting of fluoride, calcium pyrophosphate, sodium tripolyphosphate, zinc citrate, calcium hydrogen phosphate, peppermint oil, spearmint oil, sorbitol and sorbitan, and mixtures thereof. Other compounds known in the art may for these purposes may be used, as well.

The pet chew may also function as a delivery system to deliver pharmaceutical agents to the pet. The pharmaceutical agents are selected from the group consisting of anti-inflammatory agents, antibiotics, anti-parasitic agents, and animal-coat enhancing compounds, but may include other compounds as well. Either the chewable material or the filling may incorporate the pharmaceutical agent in the recommended dosage for the size of animal to consume the product, as is known in the art. For instance, it is contemplated that the filling for the receptacle be pre-formed, so as to incorporate a specified dosage of a pharmaceutical agent in the filling.

The filling may be prepared outside the receptacle by molding it into a mold having a shape corresponding to the receptacle and simply inserting the pre-formed filling into the receptacle. In this embodiment, the ingredient(s) of the filling are mixed and placed into molds configured to conform to the shape and size of the recesses machined in the dog chew. Fixing means, such as a non-toxic food grade quality hot melt adhesive or gel may be added to the plug ingredients. The molded plug may be hardened by heat sealing or by heating under pressure. The hardened plug is then forcibly, manually inserted or plugged into the receptacle.

It is desirable to dehydrate the rawhide chew toy to reduce the moisture content and thereby reduce the water activity of the rawhide article. This reduces the likelihood that growth of mold, bacteria, fungus and the like will contaminate the chew toy. However, insufficient moisture will result in a hard and brittle chew. “Water activity” is defined as the ratio of the vapor pressure exerted by the water contained in a product to the vapor pressure of pure water at the same temperature (The Encyclopedia of Food Science, AVI Publishing). The chew is dried and sterilized by exposing the filled chew to a suitable temperature for a sufficient time to effect drying and sterilizing. The chew is dried to a moisture content preferably less than 13% moisture, so that the water activity level of the chew is preferably below about 0.75. The product is then packaged in moisture-proof packaging.

It will be understood that the embodiments described herein are merely exemplary and that a person skilled in the art may make many variations and modifications without departing from the spirit and scope of the invention. For example, the invention is not intended to be strictly limited to the named ingredients, temperatures, or other parameters. Rather, the invention as claimed extends to many possible variations not specifically detailed. All such variations and modifications are intended to be included in the scope of the invention as described herein.

We claim:

1. A consumable pet chew comprising
a formed, three-dimensional body of chewable material,
said body having an outer surface and at least one recess extending generally perpendicularly from said outer surface,
said recess having walls and a machined edge at said outer surface,
said recess defining a receptacle within said body,
a filling comprising an edible substance fixedly positioned in said receptacle.

2. The pet chew of claim 1 wherein said machined edge at said outer surface is formed by machining operations selected from the group consisting of drilling, punching, cutting and stamping.

3. The pet chew of claim 1 wherein the walls of said recess are scored during machining operations.

4. The pet chew of claim 1 wherein said receptacle is a cylindrical bore.

5. The pet chew of claim 1 wherein said receptacle is a three dimensional cavity of a desired size and configuration.

6. The pet chew of claim 1 wherein said receptacle extends only partially through said body.

7. The pet chew of claim 1 wherein said chewable material is selected from the group consisting of natural rawhide, ground and recombined rawhide, starch, casein, denatured and partially hydrolyzed collagen, thermoplastic material, non-toxic plastic, and mixtures thereof.

8. The pet chew of claim 1 wherein said filling is selected from the group consisting of rawhide, poultry, meat, pork, jerky, a meat by-product mixture, cereal, rice, vegetable, fruit, cheese, pet food, peanut butter, and mixtures thereof and binders therefor.

9. The pet chew of claim 1 wherein said filling is formed from whole pieces of an edible substance.

10. The pet chew of claim 1 wherein said filling is formed from discrete particles of an edible substance.

11. The pet chew of claim 1 wherein said filling comprises a processed mass.

12. The pet chew of claim 1 wherein said filling is substantially level with the outer surface of said body.

13. The pet chew of claim 1 wherein said filling extends outwardly from said receptacle.

14. The pet chew of claim 1 wherein at least one of said chewable material and said filling is flavored with a flavoring agent.

15. The pet chew of claim 1 wherein at least one of said chewable material and said filling is colored with a colorant.

16. The pet chew of claim 1 wherein at least one of said chewable material and said filling is scented.

17. The pet chew of claim 1 wherein at least one of said chewable material and said filling further contains at least one additional ingredient selected from the group comprising nutrients, dental additives, pharmaceutical compounds and mixtures thereof.

18. The pet chew of claim 17 wherein said nutrients are selected from the group consisting of vitamins, minerals, herbs, anti-oxidants, and nutritional supplements.

19. The pet chew of claim 17 wherein said pharmaceutical compounds are selected from the group consisting of anti-inflammatory agents, antibiotics, anti-parasitic agents, and animal-coat enhancing compounds.

20. The pet chew of claim 1 wherein said receptacle and said filling are sized and configured so that said filling is retained in said receptacle by friction fit.

21. The pet chew of claim 1 wherein said filling is pre-formed and pressed into said receptacle.

22. A method of making a consumable pet chew, comprising the steps of:
a. forming an edible, chewable material into a three dimensional body;
b. removing a portion of said body to form at least one recess having walls and defining a receptacle in said body;
c. forming an edible filling; and
d. fixedly positioning said filling in said receptacle.

23. The method of claim 22 wherein step b. includes the step of scoring the walls of said recess during machining operations.

24. The method of claim 22 wherein said receptacle is a cylindrical bore.

25. The method of claim 22 wherein said receptacle is a three dimensional cavity of a desired size and configuration.

26. The method of claim 22 wherein said receptacle extends only partially through said body.

27. The method of claim 22 wherein said chewable material is selected from the group consisting of natural rawhide, ground and recombined rawhide, starch, casein, denatured and partially hydrolyzed collagen, thermoplastic material, non-toxic plastic, and mixtures thereof.

28. The method of claim 22 wherein said filling is selected from the group consisting of rawhide, poultry, meat, pork, jerky, a meat by-product mixture, cereal, rice, vegetable, fruit, cheese, pet food, peanut butter, and mixtures thereof and binders therefor.

29. The method of claim 22 wherein said filling is formed from whole pieces of an edible substance.

30. The method of claim 22 wherein said filling is formed from discrete particles of an edible substance.

31. The method of claim 22 wherein said filling comprises a processed mass.

32. The method of claim 22 wherein at least one of said chewable material and said filling is flavored with a flavoring agent.

33. The method of claim 22 wherein at least one of said chewable material and said filling is colored with a colorant.

34. The method of claim 22 wherein at least one of said chewable material and said filling is scented.

35. The method of claim 22 wherein at least one of said chewable material and said filling further contains at least one additional ingredient selected from the group comprising nutrients, dental additives, pharmaceutical compounds and mixtures thereof.

36. The method of claim 35 wherein said nutrients are selected from the group consisting of vitamins, minerals, herbs, anti-oxidants, and nutritional supplements.

37. The method of claim 35 wherein said pharmaceutical compounds are selected from the group consisting of anti-inflammatory agents, antibiotics, anti-parasitic agents, and animal-coat enhancing compounds.

38. The method of claim 22 wherein said filling is pre-formed and pressed into said receptacle.

39. The method of claim 22 wherein said filling is fixedly positioned in said receptacle by means of friction fit.

40. The method of claim 22 wherein said filling is fixedly positioned in said receptacle by means of edible glue.

41. The method of claim 22 wherein said filling is fixedly positioned in said receptacle by means of a removable covering.

42. The method of claim 22 wherein said filling is fixedly positioned in said receptacle by sealing said filling in said receptacle by means of a thermosetting edible compound.

43. The method of claim 22 wherein said filling comprises slices of meat and steps c. and d. comprise twisting said slices of meat and forcing said twisted slices into said receptacle so that said twisted slices conform to the size and configuration of said receptacle and are retained in position therein.

44. The method of claim 22 including, after step d., an additional step of shaping the top surface of the filling to the desired configuration.

45. The method of claim 22 including, after step d., an additional step of drying and sterilizing said pet chew by exposing said filled pet chew to a suitable temperature for a sufficient time to effect drying and sterilizing.

46. The method of claim 45 including, after said drying and sterilizing step, the step of wrapping said filled pet chew to prevent oxidation.
